(19) United States
(12) Patent Application Publication
(10) Pub. No.: US 2003/0004389 A1
(43) Pub. Date: Jan. 2, 2003

(54) Process to render nuclear waste into a stable mass

(76) Inventor: William Donald Simmons, Holladay, UT (US)

Correspondence Address: WILLIAM SIMMONS, 2435 OKESON CIRCLE, HOLLADAY, UT, 84117, US

(21) Appl. No.: 10/180,873

(22) Filed: Jun. 26, 2002

Related U.S. Application Data
(60) Provisional application No. 60/302,281, filed on Jul. 2, 2001.

(51) Int. Cl. G21F 9/00

(52) U.S. Cl. 588/1

(57) ABSTRACT

A stable treatment process for a radioactive material (100) includes combining a sufficient minority ratio of said material (100) and a sufficient quantity ratio of a suitable moderator material (102) within a sufficient majority ratio mass of suitable benign radioactive poison metals (104). The benign radioactive poison metals (104) shall include a minimum of one benign radioactive poison metal Lead. Said radioactive material (100), moderator (102) and benign radioactive poison metal (104) being sufficiently combined results in unstable combined mass (105). Said mass (105) consisting of constituents (100,102,104) is impacted by suitable means producing sufficient force (63) from impact upon mass (105) to render (64) sufficient high-pressure four dimensional complete inelastic collisions amongst the constituents (100,102,104) within combined mass (105). As rendered (64), complete activated diffusion of the constituents (100,104) results as the crystal lattice and atomic structures of the minority material (100) combines with the crystal lattice and atomic structures of the majority benign metals (104). Whereby the minority ratio of radioactive isotopes of said material (100) are wrought and quickened into the majority ratio of stable isotopes of benign radioactive poison metals (104) by means of complete inelastic collisions from said force (63) resulting in complete diffusion of constituents (100,104). Thus combined and impacted unstable mass (105) is rendered (64) into a benign stable mass (107) unable to further undergo radioactive decay.

### BACKGROUND OF THE INVENTION

This metallurgy Process is a novel, low-cost, non-reversible, systematic treatment that stabilizes radioactive isotopes contained in, but not limited to, spent nuclear fuel. For example, nuclear fuels that are used to fuel Nuclear Power Reactors that generate electricity by nuclear fission, over time, lose fissile efficiency. This used fuel, known as spent nuclear fuel, is replaced with fresh nuclear fuel known as enriched uranium. Spent nuclear fuel is considered by the nuclear industry to be High Level Waste Uranium (HLW). Currently HLW Uranium is treated in many different ways to contain its radioactivity for storage in temporary facilities, disposal in deep underground depositories or it is re-cycled. Even though the radioactivity in HLW Uranium is contained by these methods, it still has the ability to emit high levels of radiation. Unlike current nuclear waste management practices, the result from the novel Process introduced here will make untreated HLW Uranium spent fuel from a reactor stable. The benefit from this Process to make Uranium nuclear waste stable will be the elimination of long-term or temporary above ground storage sites and permanent deep underground disposal facilities because the HLW Uranium treated by this new Process is stable and safe to handle. Spent Nuclear fuel is but one example of any radioactive isotopes that this invention is suitable for.

Many waste treatment processes utilize thermal energy to break up and metal alloy to contain radioactive material as referenced in the prior patents. However contained by these processes, the material is still radioactive and still capable of undergoing radioactive decay. This invention does more than simply contain the radioactivity, it spontaneously reduces the radioactivity to a level whereby said radioactive material is unable to further undergo radioactive. Making it benign.

No other patents can claim that.

### BRIEF SUMMARY OF THE INVENTION

This invention relates to a nuclear waste treatment process utilizing benign and stable radioactive poison metals. More specifically, the invention relates to a treatment process whereby radioactive isotopes are rendered benign and unable to further undergo radioactive decay by forcing the diffusion of the atomic structure of said radioactive isotopes into the atomic structure of the benign radioactive poison metals as caused by this invention.

### BRIEF DESCRIPTION OF DRAWINGS

The drawings presented support the embodiment Example contained in the Detailed Description and the Abstract of the Disclosure.

### DETAILED DESCRIPTION

### Acceleration

A process to render nuclear waste into a stable mass requires an Accelerated Atomic Decay (AAD) of radioactive isotopes.

### Dilution

Said radioactive Mass is diluted when added to a majority percentage of benign metal Mass.

### A Procedure

AAD results from this invention's Accelerated Dilute In-quart Oxidizing Reduction Stabilization Procedure (ADIORS) and parts thereof. A.D.I.O.R.S. is a systematic procedure in a process that stabilizes radioactive isotopes contained in specific host material.

### General Premise

Radioactive isotopes of uranium naturally decay into stable lead 206. However, a natural process takes 10's of thousands of years to occur leaving radioactive prodigy and daughters each step of the way.

Minority atoms in a dominant matrix can and do attach to any solid substrate that has the same crystal structure and similar lattice spacing to which the minority atoms would eventually adopt. The elimination of radioactive isotopes results from a secondary reaction in this invention's metallurgical procedure. Therefore, as example, the following can become:

U238>Pb206, Th234>Pb206, Pr234>Pb206, U234>Pb206, Th230>Pb206, Ra226>Pb206, Rn222>Pb206, Po218>Pb206, Pb214>Pb214, Bi214>Pb206, Po214>Pb206, Pb210>Pb206, Bi210>Pb206, Po210>Pb206

In each instance, further decay prodigy is aborted. Radioactive isotopes are liberated of their radioactivity when a 4-dimensional, complete in-elastic collision of minority ratio radioactive isotope collide within a solid matrix of majority ratio benign radioactive poison metal isotope, such as the stable isotopes of bismuth and lead, with sufficient force to implode upon and break the nuclear bonds of the radioactive isotopes. Such force above zero PSI (pounds per square inch) to three hundred thousand PSI and beyond shall be sufficient as determined required per specific application.

Such variation of force is easily attainable utilizing specific impact machinery and or high pressure presses common within today's heavy industrial industries.

As this collision occurs, the atoms within the matrix become agitated, an activated complex results and nuclear bonds become weakened while in this agitated state. Extreme pressure is induced upon the minority radioactive isotopes by the majority benign metal matrix to initiate these reactions. This convergence on the radioactive isotopes is in the form of a 3 dimensional continuum, resulting in a complete 4 dimensional in-elastic collision. The required extreme pressure induced upon the entire matrix is by high-energy impacts to initiate said 4 dimensional collisions. And similar to an implosion, the nuclear bindings collapse under said pressure.

In said activated complex, an intermediate complex is formed by the constituents' initial reaction then decomposes spontaneously to form the final product.

The rate of collision is determined by the frequency with which the nuclei are made to collide with sufficient energy to overcome nuclear barrier fields-breaking their nuclear bonds, thus allowing new combinations of bonds to form with the benign radioactive poison atoms.

During this action, spontaneous liberated free neutrons from the radioactive isotopes dissipate into neutron rays, slowed down by a hydrogen rich moderator allowing for complete diffusion within the dominant benign matrix fields until equilibrium is achieved within the entire matrix. Being that the majority atoms of the matrix are benign, entropy results and the entire matrix becomes stable, unable to further undergo radioactive decay.

The final combination within the entire matrix by this invention is made to be that of the benign radioactive poison metal from a reaction triggered by a means of concentrated spontaneous high pressure upon the matrix, resulting in the original radioactive isotope spontaneously undergoing an accelerated atomic decay (AAD) into its inevitable benign metal isotope without producing further radioactive prodigy.

### EXAMPLE

The following described embodiment is intended to illustrate the principles of the invention, but not to limit the scope of the invention.

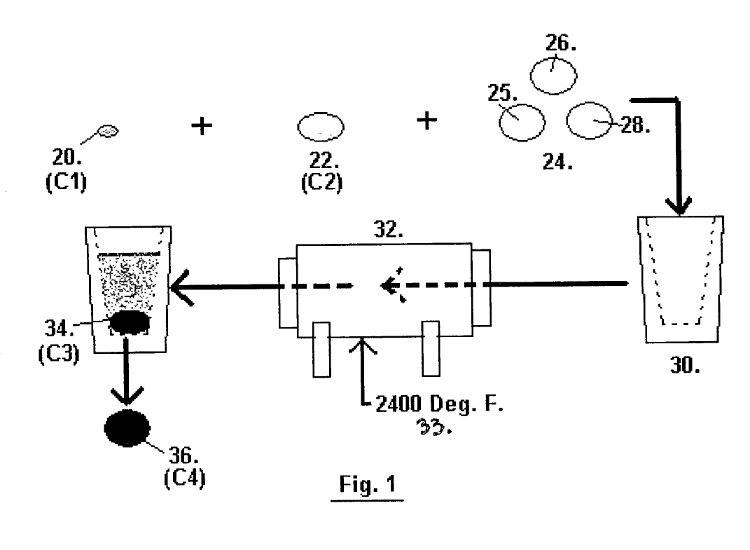

### First Step of Process as shown in FIG. 1 as Follows

### Accelerated Dilute Phase (100)

1. One gram by weight of Spent Nuclear Reactor Fuel (HLW) Uranium Oxide powdered Mass (C1) 20 that has been reduced to metal, nine grams by weight of Depleted Uranium Oxide powdered Mass (C2) 22 that has been reduced to metal and three grams of suitable flux 24 to promote fusing of metals and to prevent the formation of new oxides such as one gram of powdered borax 25, one gram of powdered silica 26 and one gram of wheat flour 28 are put into a vessel made of refractory substance used for melting materials at high temperatures such as a 250 ml zirconium crucible 30. Said vessel, containing said ingredients, is placed inside a suitable high temperature furnace such as an induction furnace 32 and the ingredients inside the vessel are made to melt at a sufficient temperature of 2400 degrees F. 33 so that a combined molten metal mass (C3) 34 made up of said Mass (C1) 20 and (C2) 22 settles to the bottom inside said vessel 30. Said combined molten metal Mass (C3) 34 is allowed to cool to a solid metal Mass (C4) 36.

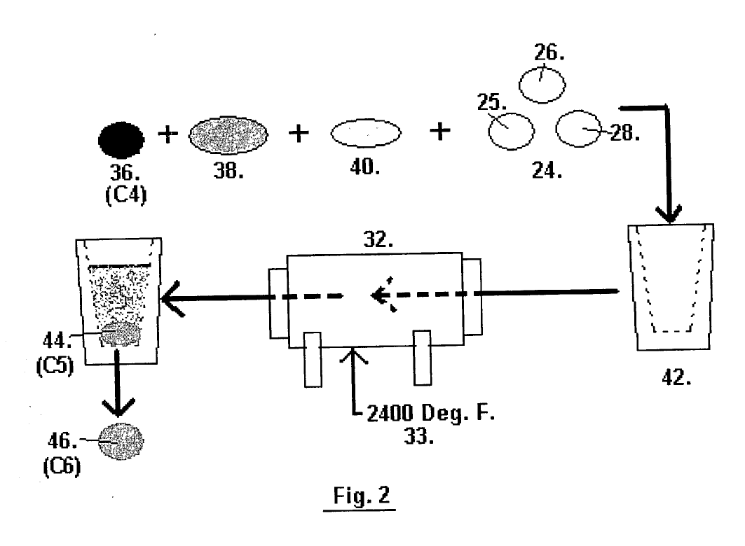

### Second Step of Process as Shown in FIG. 2 as Follows

### First In-Quart Phase Including AAD (100, 102, 104, 105)

2. Said solid metal Mass (C4) 36, ninety grams by weight of a soft, dense, benign metallic element mass that melts at a low temperature such as powdered Bismuth 38, and thirty grams of a suitable moderator substance used to promote nuclear fission such as powdered graphite 40, and ten grams each said components 25, 26, 28 of said flux 24 to promote fusing of metals and to prevent the formation of new oxides are put into a vessel made of refractory substance used for melting materials at high temperatures such as a 500 ml zirconium crucible 42. Said vessel 42 containing said ingredients, is placed inside said high temperature furnace 32 and the ingredients inside said vessel are made to melt at said temperature 33 so that a combined molten metal mass (C5) 44 consisting of said Mass (C4) 36 and said Bismuth 38 settles to the bottom inside the vessel. Said combined molten metal Mass (C5) 44 is allowed to cool to a solid metal alloy (C6) 46.

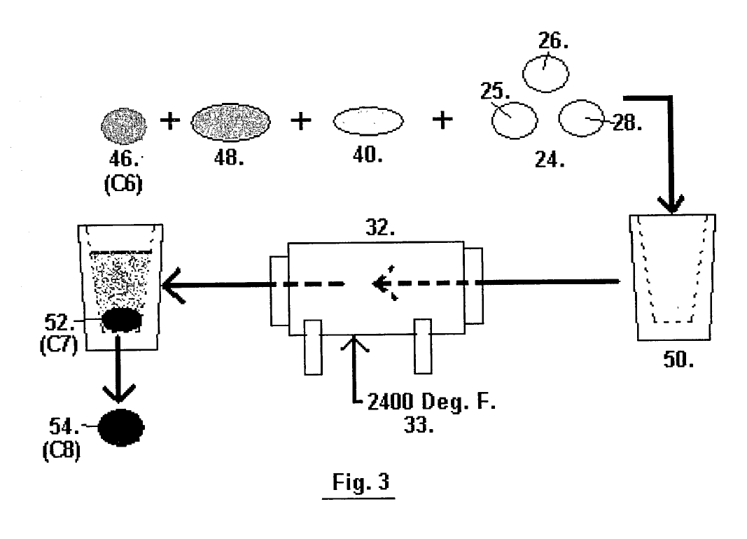

### Third Step of Process as Shown in FIG. 3 as Follows

### Second In-Quart Phase (100, 102, 104, 105)

3. Said solid metal alloy Mass (C6) 46, one-hundred eighty grams of a soft, dense, benign metallic element mass that melts at a low temperature such as Lead 48, sixty grams of said moderator substance used to promote nuclear fission such as powdered graphite 40 and twenty grams each of the components 25, 26, 28 of the flux 24 to promote fusing of metals and to prevent the formation of new oxides are put into a vessel made of refractory substance used for melting materials at high temperatures such as a 1000 ml zirconium crucible 50. Said vessel 50, containing ingredients, is placed inside the high temperature furnace 32 and the ingredients inside the vessel 50 are made to melt at the temperature 33 so that a combined molten metal mass (C7) 52 consisting of said Mass (C6) 46 and said Lead 48 settles to the bottom inside the vessel. Said molten metal Mass (C7) 52 is allowed to cool to a solid metal alloy (C8) 54.

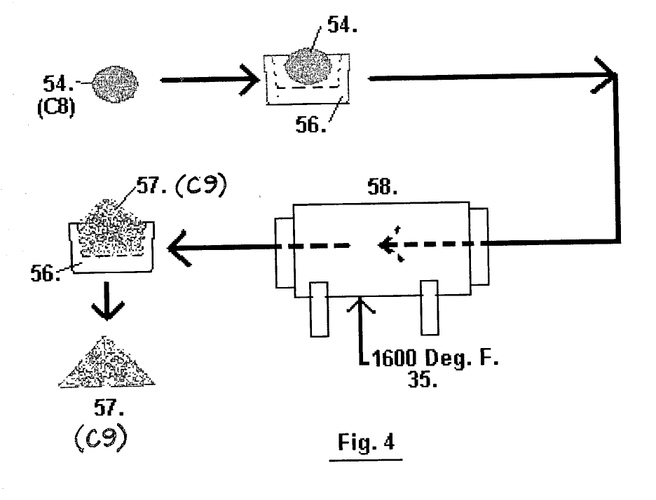

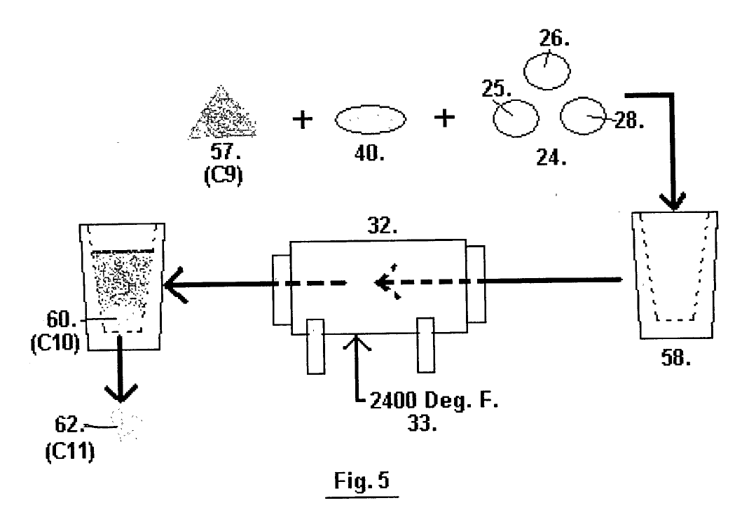

### Fourth Step of Process as Shown in FIG. 4 as Follows

### Oxidizing Phase (100, 102, 104, 105)

4. Said solid metal alloy Mass (C8) 54, is placed in porous vessel of sufficient size that is made of suitable material such as a Bone Ash Cupel Dish 56 that promotes the oxidation of non-noble metals under oxidizing conditions in a high temperature furnace suitable for the oxidation of non-noble metals such as an oxidizing induction furnace 58. Said vessel 56 containing the metal alloy Mass (C8) 54 is placed in a high temperature furnace at 1600 Deg. F. 35 under suitable oxidizing conditions for a sufficient time to cause the complete oxidation of metal alloy Mass (C8) 54 into amorphous oxidized Mass (C9) 57. Said amorphous Mass (C9) 57 is allowed to cool.

### Fifth Step of Process as Shown in FIG. 4 as Follows

### Reduction Phase (100, 102, 104, 105)

5. The amorphous Mass (C9) 57, sixty grams of the moderator substance used to promote nuclear fission such as powdered graphite 40 and twenty grams each of the components 25, 26, 28 of the flux 24 to promote fussing of metal and to prevent the formation of oxides are put in a vessel made of refractory substance used for melting materials at high temperatures such as a 1000 ml crucible 58. Said vessel 58 containing said ingredients, is placed in the high temperature furnace 32 and the ingredients inside the vessel 58 are made to melt at said temperature 33 under reducing conditions so that a combined molten metal Mass (C10) 60 settles to the bottom of the vessel. Said molten metal Mass (C10) 60 is allowed to cool into a solid metal MASS (C11) 62.

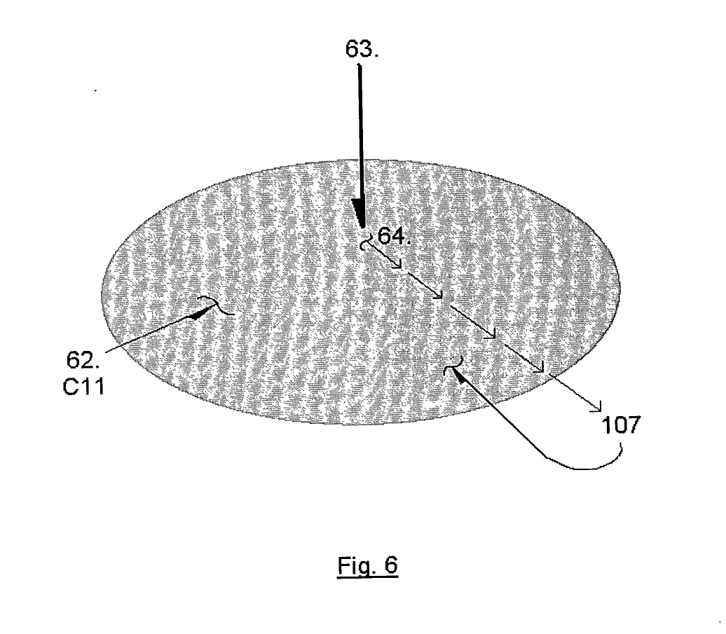

### Item Six as Shown in FIG. 6

### A Secondary Reaction in a Metallurgical Procedure

### Stabilization (63, 64, 105,107)

6. The HLW Mass (C1) 20, as thusly diluted through said steps 1, 2, 3, 4, 5 into a solid metal Mass (C11) 62 and thereby is rendered 64 by sufficient means such as, but not limited to heavy blows and impact(s) upon said Mass to force sufficient pressure (63) upon entire Mass (C11) to render a resulting suitable reaction within said mass by said pressure, whereby Mass 107 (C11) is rendered stable and safe to handle.

What is claimed is:

1. A method of treatment to render a minimum of one radioactive isotope into a host stable mass so that it is unable to further undergo radioactive decay.

2. A method to render a minimum of one radioactive isotope benign within a host majority mass of stable isotopes and stable radioactive poison metal isotopes.

3. A method referred to in claim 2 that includes Lead as radioactive poison metal isotopes.

4. A method referred to in claim 2 that includes Bismuth as radioactive poison metal isotopes.

5. A method referred to in claim 2 that includes a suitable hydrogen rich moderator of sufficient ratio with the radioactive and stable isotopes as part of the host stable mass.

6. A method referred to in claim 2 that combines into an unstable mass a sufficient minority ratio of radioactive isotopes and a sufficient intermediate ratio of a suitable moderator within a sufficient ratio of suitable stable radioactive poison metal isotopes.

7. A method referred to claim 2 that include a suitable means to superimpose sufficient impact and or pressure upon unstable mass referred to in claim 6 that causes suitable pressure within this mass to cause a minimum chain of reactions claimed by this invention.

8. A method of process to prepare a combined mass referred to in claim 6 that employs a minimum of one following pyro-metallurgical exercises: dilution, reduction, in-quart, cupel-oxidizing operations prior to method referred to in claim 7.

9. A method referred to in claim 2 that provides a suitable means to cause a complete inelastic collision of a minimum of one radioactive isotope with a majority of stable radioactive poison metal isotopes.

10. A method referred to in claim 2 that causes a complete diffusion of a minimum of one radioactive isotope with a majority of stable radioactive metal isotopes.

11. A method referred to in claim 2 suitable to cause nuclear bonds to break so that nucleus constituents of a minimum of one radioactive isotope replicates to the atomic structure of majority stable radioactive poison metal nuclei constituents while excess neutrons dissipate as neutron rays.

12. A method referred to in claim 2 that causes sufficient high-pressure to be generated within the host mass.

13. A method referred to in claim 2 that causes sufficient complete four dimensional continuum implosive forces within the host mass.

14. A method referred to in claim 1 that does not produce radioactive prodigy and aborts radioactive daughters.

15. A method referred to in claim 2 that includes Litharge as radioactive poison metal isotopes.

16. A method referred to in claim 2 that includes graphite and or black paraffin as moderator stable isotopes.

17. A method referred to in claim 2 that includes a suitable means of impact upon host mass of more than one PSI (pounds per square inch) to three hundred thousand PSI, and beyond.
